(19) United States
(12) Patent Application Publication
(10) Pub. No.: US 2016/0298812 A1
(43) Pub. Date: Oct. 13, 2016

(54) LED light bulb

(71) Applicant: Yu-Syuan CHEN, New Taipei City (TW)

(72) Inventor: Yu-Syuan CHEN, New Taipei City (TW)

(21) Appl. No.: 14/682,109

(22) Filed: Apr. 9, 2015

(51) Int. Cl. F21K 99/00; F21V 23/06; F21V 29/77; F21V 23/00

(52) U.S. Cl. CPC F21K 9/1355; F21V 23/005; F21V 23/06; F21V 29/77

(57) ABSTRACT

A LED light bulb is coupled with a bulb holder which connects with a power source and contains: a body, a circuit unit, an illumination unit. The body includes a first shell, a second shell coupled with the first shell, an accommodating chamber defined between the first shell and the second shell, and a connecting section connected with the bulb holder. The connecting section has a first opening and a second opening which pass through the connecting section. The circuit unit is accommodated in the accommodating chamber and includes a driving circuit, a first electrode, and a second electrode. The first electrode is electrically connected with a first power contact in the bulb holder through the first opening, and the second electrode is electrically connected with a second power contact in the bulb holder via the second opening. The illumination unit is electrically connected with the driving circuit.

### FIELD OF THE INVENTION

The present invention relates to a LED light bulb which is produced easily.

### BACKGROUND OF THE INVENTION

A light-emitting diode is driven by direct current, so a conventional light-emitting diode bulb contains a conversion circuit for converting alternating current into the direct current to drive the light-emitting diode. Since the light-emitting diode is broken at high temperature, and the light-emitting diode bulb also contains plural dissipating fins for dissipating heat of the light-emitting diode bulb to avoid a damage of the light-emitting diode bulb at the high temperature. Preferably, the light-emitting diode bulb is electrically connected with a bulb holder by using the conversion circuit.

For example, another conventional light-emitting diode bulb is disclosed in TW Patent No. I384170 and contains a dissipating casing, a metal cap, a driving circuit board, an illuminating piece, a gasket, and a lampshade. The dissipating casing includes an opening defined on a first end thereof and a connecting hole formed on a second end thereof. The metal cover is fixed on the connecting hole of the dissipating casing, and the driving circuit board is mounted in the dissipating casing and is electrically connected with the metal cap. The illuminating piece and the gasket are arranged in the opening, such that the illuminating piece is electrically coupled with the driving circuit board. A modular light emitting diode bulb is disclosed in TW Patent No. 455988 and contains: a lampshade, an illuminating plate printed an electric circuit and having plural light-emitting diode covering elements, a light cap, a bulb holder, and a driving module printed an electric circuit and electrically connected with a plurality of electronic components; wherein the illuminating plate has a female joining seat; the light cap has a first opening end, a second open end, and a screwing portion; the bulb holder has a connecting element, an insulating element, and a contacting element; the driving module has a male joining seat, a ground wire, and a live wire; the first open end of the light cap is covered on the illuminating plate, the female joining seat is in connection with the male joining seat, the ground wire contacts with the contacting element of the bulb holder, the live wire contacts with the contacting element of the bulb holder, and the contacting element is screwed with the screwing portion of the light cap.

However, the modular light emitting diode bulb is produced complicatedly and troublesomely.

The present invention has arisen to mitigate and/or obviate the afore-described disadvantages.

### SUMMARY OF THE INVENTION

The primary objective of the present invention is to provide a LED light bulb which is produced easily

To obtain above objective, a LED light bulb provided by the present invention contain: a body, a circuit unit, an illumination unit.

The body includes a first shell, a second shell coupled with the first shell, an accommodating chamber defined between the first shell and the second shell, and a connecting section connected with the bulb holder.

The connecting section has a first opening and a second opening which pass through the connecting section.

The circuit unit is accommodated in the accommodating chamber and includes a driving circuit, a first electrode, and a second electrode. The first electrode is electrically connected with a first power contact in the bulb holder through the first opening, and the second electrode is electrically connected with a second power contact in the bulb holder via the second opening.

The illumination unit is electrically connected with the driving circuit.

### BRIEF DESCRIPTION OF THE DRAWINGS

FIG. 1 is a perspective view showing the exploded components of a LED light bulb according to a first embodiment of the present invention.

FIGS. 2A to 2D are a cross sectional view showing the assembly of a part of the LED light bulb according to the first embodiment of the present invention.

FIG. 3A is a cross sectional view showing the assembly of a part of the LED light bulb according to the first embodiment of the present invention.

FIG. 3B is a cross sectional view showing the assembly of a part of the LED light bulb according to a second embodiment of the present invention.

FIG. 4 is a perspective view showing the exploded components of a LED light bulb according to a third embodiment of the present invention.

FIG. 5 is a perspective view showing the exploded components of a LED light bulb according to a fourth embodiment of the present invention.

FIG. 6 is a plane view showing the exploded components of a LED light bulb according to a fifth embodiment of the present invention.

FIG. 7 is a plane view showing the exploded components of a LED light bulb according to a sixth embodiment of the present invention.

### DETAILED DESCRIPTION OF THE PREFERRED EMBODIMENTS

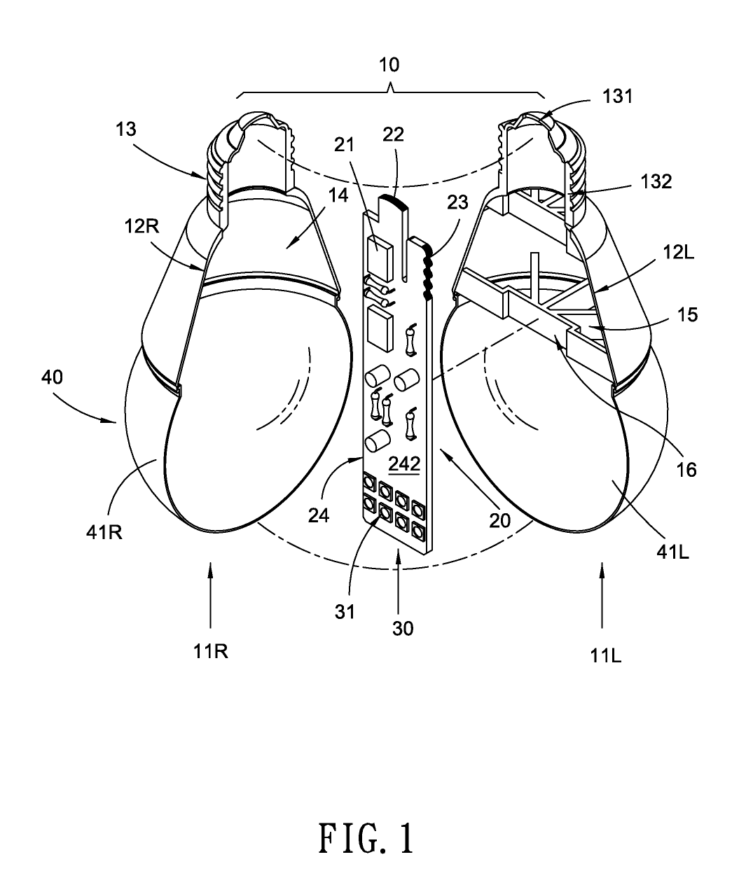

With reference to FIG. 1, a LED light bulb according to a first embodiment of the present invention comprises: a body 10, a circuit unit 20, and an illumination unit 30. The body 10 includes a first shell 11L, a second shell 11R coupled with the first shell 11L, a connecting section 13 arranged on one end thereof, and an accommodating chamber 14 defined between the first shell 11L and the second shell 11R. The connecting section 13 has a first opening 131 and a second opening 132 which pass through the connecting section 13. The circuit unit 20 is accommodated in the accommodating chamber 12 and includes a driving circuit 21, a first electrode 22, and a second electrode 23, wherein the first electrode 22 is electrically connected with a first power contact in a bulb holder (not shown) through the first opening 131, and the second electrode 23 is electrically connected with a second power contact in the bulb holder via the second opening 132. The illumination unit 30 is electrically in connection with the driving circuit 21.

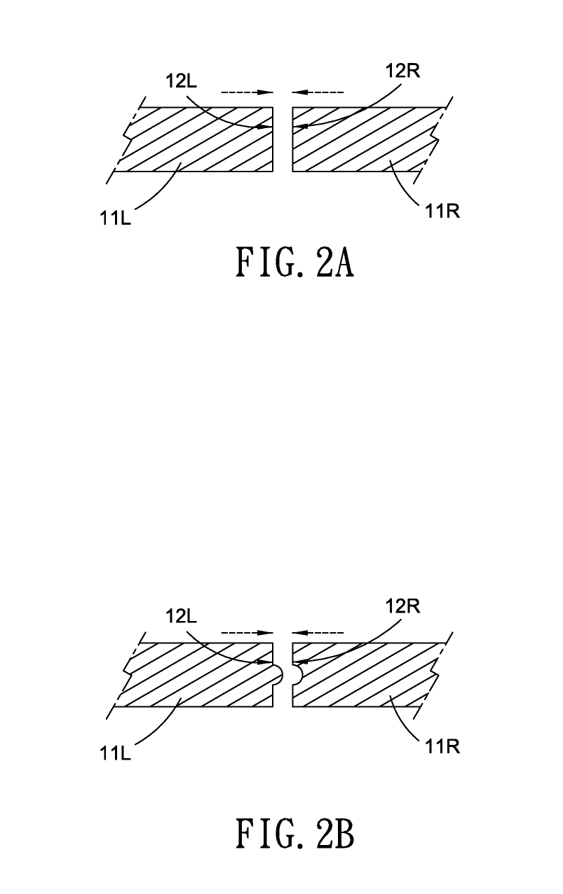

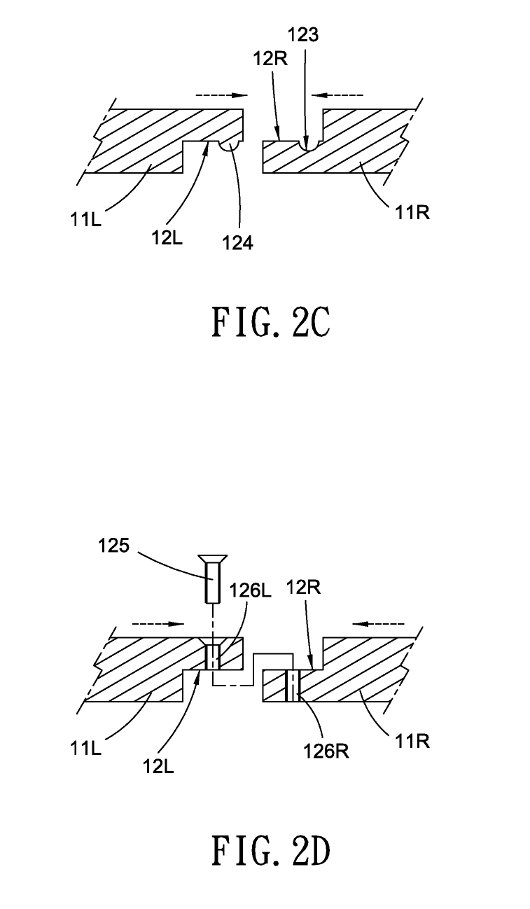

The first shell 11L and the second shell 11R is injection or extrusion molded from plastic material or other insulation material, and they are painted or electroplated. The first shell 11L has a first coupling face 12L, and the second shell 11R has a second coupling face 12R for coupling with the first coupling face 11L of the first shell 11L, wherein each of the first coupling face 12L and the second coupling face 12R is a flat surface, as shown in FIG. 2A. In another embodiment, one of the first coupling face 11L and the second coupling face 11R is a recess 121, and the other of the first coupling face 11L and the second coupling face 11R is a raised rib 122 for connecting with the recess 121, as illustrated in FIG. 2B. Alternatively, the first coupling face 12L and the second coupling face 12R are connected together in an adhesive manner and in an ultrasound fusion manner. The first coupling face 12L and the second coupling face 12R are connected together in an engagement manner as shown in FIG. 2C, for example, one of the first coupling face 12L and the second coupling face 12R is a locking notch 123, and the other of the first coupling face 12L and the second coupling face 12R is a retaining tab 124. With reference to FIG. 2D, the first coupling face 12L has a bolt element 125 (such as a countersunk bolt) and a first screwing orifice 126L, and the second coupling face 12R has a second screwing orifice 126R for corresponding to the first screwing orifice 126L, such that the bolt element 125 is screwed with the first screwing orifice 126L and the second screwing orifice 126R, thus connecting the first coupling face 121L and the second coupling face 12R together. Accordingly, the first shell 11L and the second shell 11R are removed from each other to replace at least one LED element 31 or the circuit unit 20, after they are broken.

The circuit unit 20 is mounted in the accommodating chamber 14 and includes the driving circuit 21, the driving circuit 21, and the first electrode 22, wherein the driving circuit 21 has electronic component and a printed circuit electrically connected with the electronic component, such that the driving circuit 21 transforms power source (such as transforming alternating current into direct current or transforming direct current into alternating current) and controls the power source (such as changing voltage, stabilizing voltage, and controlling constant current). The first electrode 22 is electrically connected with the first power contact in the bulb holder, and the second electrode 23 is electrically connected with the second power contact in the bulb holder, wherein the bulb holder supplies DC power or AC power. The driving circuit 21 is electrically connected with the bulb holder through the first electrode 22 and the second electrode 23, such that the DC power or the AC power of the bulb holder is transformed to drive the at least one LED element 31 to illume lights. The driving circuit 21, the first electrode 22, and the second electrode 23 are fixed on a circuit board 24, and the circuit board 24 is secured in the accommodating chamber 14 of the body 10.

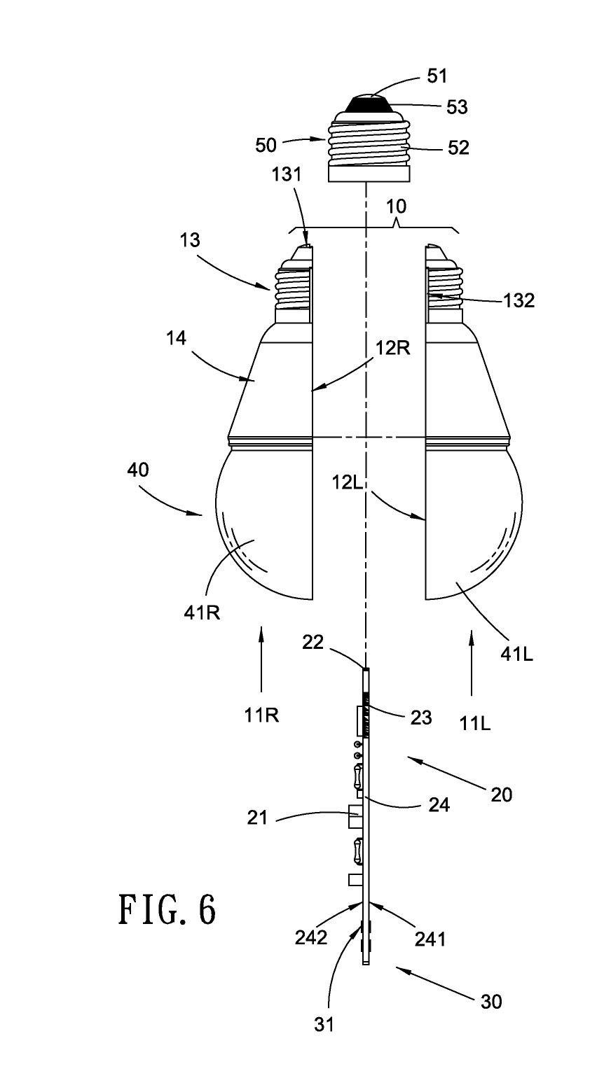

The illumination unit 30 includes the at least one LED element 31 electrically connected with the circuit unit 20 for driving the at least one LED element 31 to illuminate the lights. The at least one LED element 31 is disposed on a first rim 241 (as shown in FIG. 6) of a front section of the circuit board 24 and a second rim 242 (as illustrated in FIG. 1) of the front section of the circuit board 24 opposite to the first rim 241, and the front section of the circuit board 24 extends into a transparent cover 40.

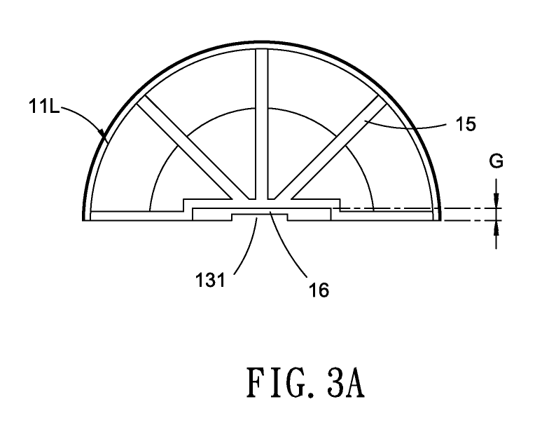

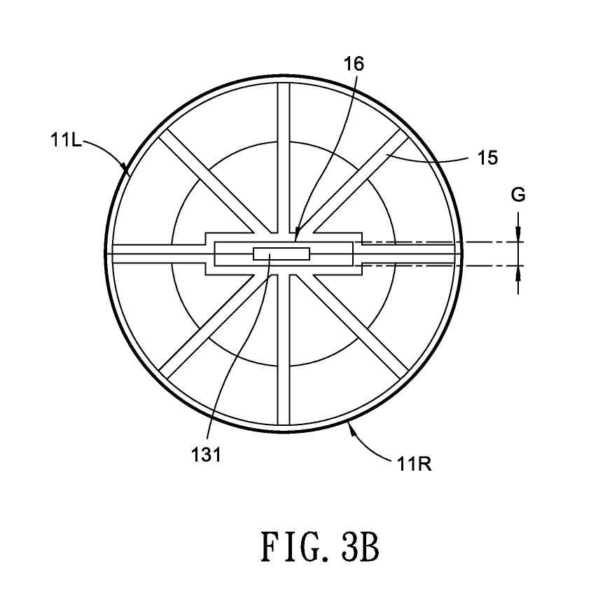

With reference to FIG. 3A, in one embodiment, one of the first shell 11L and the second shell 11R has at least one reinforcement rib 15 formed on an inner surface thereof or both of the first shell 11L and the second shell 11R have at least one reinforcement rib 15 formed on two inner surfaces thereof (as shown in FIG. 3A), wherein the at least one reinforcement rib 15 extends radially from the accommodating chamber 14 to an inner wall of the body 10 to reinforce the first shell 11L and the second shell 11R and to enhance heat dissipation area. In one embodiment, the accommodating chamber 14 of the body 10 also includes a holding plate 16 for holding and fixing the circuit board 24 of the circuit unit 20, wherein the holding plate 16 has a gap G for retaining the circuit board 24 of the circuit unit 20. In assembly, the circuit board 24 is retained with the gap G of the holding plate 16, the second shell 11R is covered so that the first shell 11L and the second shell 11R clamp the circuit board 24. Alternatively, the first shell 11L and the second shell 11R are connected together to form the body 10, and then the circuit board 24 is inserted into the gap G.

Referring to FIG. 3B, in another embodiment, each of the first shell 11L and the second shell 11R has a reinforcement rib 15 and a holding plate 16 to fix the circuit board 24 of the circuit unit 20 and to reinforce and dissipate the first shell 11L and the second shell 11R.

With reference to FIG. 1, the body 10 includes a connecting section 13, an accommodating chamber 14, and a transparent cover 40, wherein the transparent cover 40 has a first part 41L formed on the first shell 11L and a second part 41R formed on the second shell 11R.

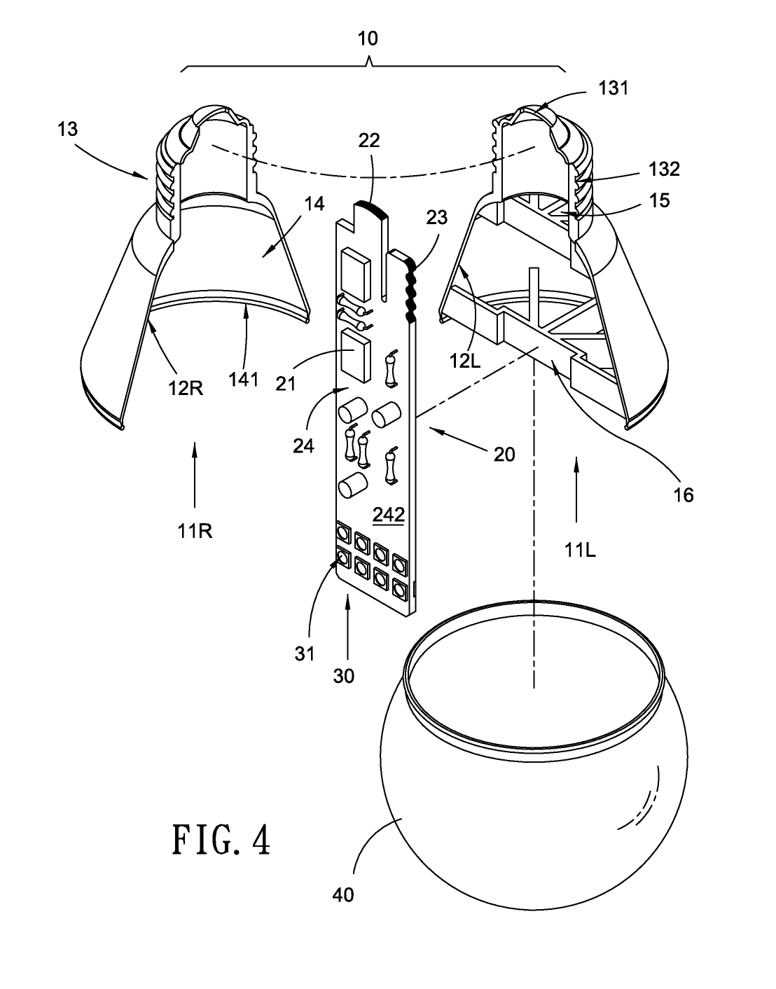

Referring to FIG. 4, the body 10 includes a connecting section 13 and an accommodating chamber 14, wherein the accommodating chamber 14 has an opening 141 for coupling with the transparent cover 40.

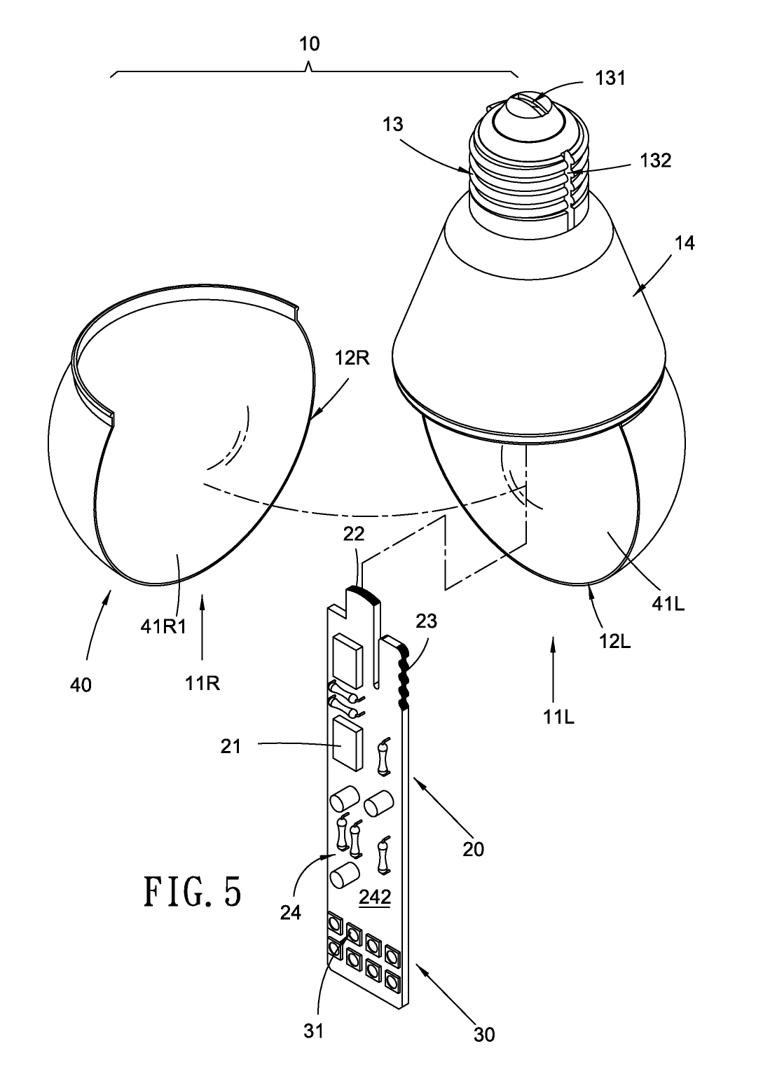

As shown in FIG. 5, the body 10 includes a connecting section 13, an accommodating chamber 14, and a transparent cover 40, wherein the first shell 11L has the connecting section 13 and the accommodating chamber 14, and the transparent cover 40 has a first part 41L formed on the first shell 11L and connecting with the accommodating chamber 14, the transparent cover 40 also has an independent second part 41R1 joining with the first part 41L and the accommodating chamber 14 of the first shell 11L.

A profile of the connecting section 13 matches with the bulb holder, wherein after the first shell 11L and the second shell 11R are connected together, the connecting section 13 has a first opening 131 and a second opening 132 which are elongated or circular, and the first opening corresponds to the first power contact, the second opening 132 corresponds to the second power contact. The circuit board 24 of the circuit unit 20 is mounted in the accommodating chamber 14, the first electrode 22 and the second electrode 23 of the circuit unit 20 are electroplated on the circuit board 24, the first electrode 22 of the circuit unit 20 is inserted into the first opening 131 of the connecting section 13 and exposes outside (as illustrated in FIG. 1), and the second electrode 23 of the circuit unit 20 is inserted into the second opening 132 of the connecting section 13 and exposes outside, wherein the connecting section 13 is in connection with the bulb holder, and the first electrode 22 is electrically connected with the first power contact, the second electrode 23 is electrically coupled with the second power contact.

As shown in FIG. 6, the first opening 131 and the second opening 132 of the connecting section 13 is elongated or circular, and a metal connector 50 is joined with the connecting section 13, wherein the metal connector 50 includes a third electrode 51, a fourth electrode 52, and an insulator 53 defined between the third electrode 51 and the fourth electrode 52 to insulate the third electrode 51 from the fourth electrode 52. The first electrode 22 of the circuit unit 20 is electrically connected with the third electrode 51 via the first opening 131 of the connecting section 13. For example, an electric wire is welded with the third electrode 51 or is inserted through the first opening 131 to contact with the third electrode 51.

The second electrode 23 of the circuit unit 20 is electrically connected with the fourth electrode 52 via the second opening 132 of the connecting section 13. For example, an electric wire is welded with the fourth electrode 52 or is inserted through the second opening 132 to contact with the fourth electrode 52. When the metal connector 50 is joined with the bulb holder, the third electrode 51 of the metal connector 50 is electrically connected with the first power contact, and the fourth electrode 52 of the metal connector 50 is electrically connected with the second power contact. Preferably, the metal connector 50 is replaced based on various specifications and types to cooperate with the bulb holder.

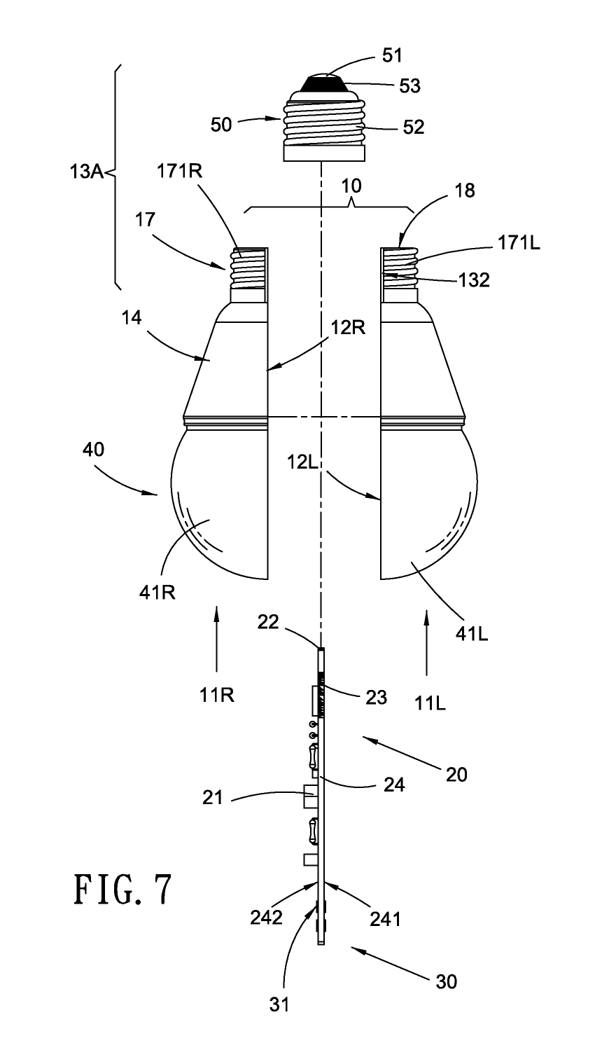

With reference to FIG. 7, a difference of a LED light bulb of a sixth embodiment from that of the first embodiment comprises:

a body 10, a circuit unit 20, an illumination unit 30, and a metal connector 50. The body 10 includes a first shell 11L, a second shell 11R coupled with the first shell 11L, a connecting section 13 arranged on a first end thereof, and an accommodating chamber 14 defined between the first shell 11L and the second shell 11R. The body 10 further includes a joining portion 17 and an accommodating chamber 14, the joining portion 17 has a first attachment portion 171 L arranged on the first shell 11L and a second attachment portion 171R arranged on the second shell 11R to couple with the first attachment portion 171L, the joining portion 17 has a second opening 132 and a mouth 18 defined on a top surface thereof, wherein the metal connector 50 is fitted with the joining portion 17 to form a connecting section 13A for connecting with the bulb holder. For instance, each of the first attachment portion 171L and the second attachment portion 171R of the joining portion 17 has threads arranged thereon so that the metal connector 50 is screwed with the joining portion 17. The circuit unit 20 is fixed in the accommodating chamber 14 and includes a driving circuit 21, a first electrode 22, and a second electrode 23, wherein the first electrode 22 is electrically connected with the third electrode 51 of the metal connector 50 through the mouth 18, and the second electrode 23 is electrically connected with the fourth electrode 52 of the metal connector 50 via the second opening 132. Furthermore, the illumination unit 30 is secured in the transparent cover 40 and is electrically in connection with the driving circuit 21.

The connecting section 13 and the metal connector 50 cooperate with the bulb holder. As shown in FIG. 1, the connecting section 13 is electrically connected with the bulb holder which is coupled with a power supply, wherein the connecting section 13 is an Edison screw cap (such as E22, E26 or E27). In addition, the connecting section 13 and the metal connector 50 are connected together to form an Edison screw cap or a Bayonet cap.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A LED light bulb being in connection with a bulb holder which is coupled with a power source, the LED light bulb comprising:
a body including a first shell, a second shell coupled with the first shell, an accommodating chamber defined between the first shell and the second shell, and a connecting section connected with the bulb holder, wherein the connecting section has a first opening and a second opening which pass through the connecting section;
a circuit unit accommodated in the accommodating chamber and including a driving circuit, a first electrode, and a second electrode, wherein the first electrode is electrically connected with a first power contact in the bulb holder through the first opening, and the second electrode is electrically connected with a second power contact in the bulb holder via the second opening;
an illumination unit electrically in connection with the driving circuit.

2. The LED light bulb as claimed in claim 1 further comprising a transparent cover coupled with one end of the accommodating chamber of the body.

3. The LED light bulb as claimed in claim 1, wherein the body includes a transparent cover, and the transparent cover has a first part formed on the first shell and a second part formed on the second shell.

4. The LED light bulb as claimed in claim 1, wherein the body includes a transparent cover, and the first shell has the connecting section and the accommodating chamber which are formed together, the transparent cover has a first part formed on the first shell and connecting with the accommodating chamber, the transparent cover also has an independent second part joining with the first part and the accommodating chamber of the first shell.

5. The LED light bulb as claimed in claim 1, wherein the driving circuit, the first electrode, and the second electrode are fixed on a circuit board, and the circuit board is secured in the accommodating chamber of the body.

6. The LED light bulb as claimed in claim 5, wherein the first opening corresponds to the first power contact in the bulb holder, the second opening corresponds to the second power contact in the bulb holder, and the circuit board is mounted in the accommodating chamber, the first electrode and the second electrode are formed on the circuit board, the first electrode is inserted into the first opening of the connecting section and exposes outside, and the second electrode is inserted into the second opening and exposes outside, wherein the first electrode is electrically connected with the first power contact, and the second electrode is electrically coupled with the second power contact.

7. The LED light bulb as claimed in claim 5, wherein the illumination unit includes the at least one LED element electrically connected with the circuit unit, the at least one LED element is disposed on a first rim of a front section of the circuit board and a second rim of the front section of the circuit board opposite to the first rim.

8. The LED light bulb as claimed in claim 1, wherein a metal connector is joined with the connecting section, and a profile and a specification of the metal connector match with the light bulb, wherein the metal connector includes a third electrode and a fourth electrode, and the third electrode does not contact with the fourth electrode, the first electrode of the circuit unit is electrically connected with the third electrode via the first opening of the connecting section, and the second electrode of the circuit unit is electrically connected with the fourth electrode via the second opening of the connecting section.

9. The LED light bulb as claimed in claim 1, wherein one or both of the first shell and the second shell have at least one reinforcement rib formed on at least one inner surface of the first shell and the second shell, wherein the at least one reinforcement rib extends radially from the accommodating chamber to the body.

10. The LED light bulb as claimed in claim 9, wherein the driving circuit, the first electrode, and the second electrode are fixed on a circuit board, and the circuit board is secured in the accommodating chamber of the body, the accommodating chamber of the body also includes a holding plate for holding and fixing the circuit board of the circuit unit, wherein the holding plate has a gap for retaining the circuit board of the circuit unit.

11. A LED light bulb being in connection with a bulb holder which is coupled with a power source, the LED light bulb comprising:
a body including a first shell, a second shell coupled with the first shell, an accommodating chamber defined between the first shell and the second shell, and a joining portion, wherein the joining portion has a first opening and a mouth defined on a top surface thereof;
a metal connector fitted with the joining portion to form a connecting section for connecting with the bulb holder, the metal connector including a third electrode, a fourth electrode, and an insulator defined between the third electrode and the fourth electrode to insulate the third electrode from the fourth electrode;
a connecting section connected with the bulb holder, wherein the connecting section has a first opening and a second opening which pass through the connecting section;
a circuit unit accommodated in the accommodating chamber and including a driving circuit, a first electrode, and a second electrode, wherein the first electrode is electrically connected with the third electrode via the first opening, and the second electrode is electrically connected with the fourth electrode via the mouth;
an illumination unit electrically in connection with the driving circuit.

12. The LED light bulb as claimed in claim 11 further comprising a transparent cover coupled with one end of the accommodating chamber of the body.

13. The LED light bulb as claimed in claim 11, wherein the body includes a transparent cover, and the transparent cover has a first part formed on the first shell and a second part formed on the second shell.

14. The LED light bulb as claimed in claim 11, wherein the body includes a transparent cover, and the first shell has the joining portion and the accommodating chamber which are formed together, the transparent cover has a first part formed on the first shell and connecting with the accommodating chamber, the transparent cover also has an independent second part joining with the first part and the accommodating chamber of the first shell.

15. The LED light bulb as claimed in claim 11, wherein the driving circuit, the first electrode, and the second electrode are fixed on a circuit board, and the circuit board is secured in the accommodating chamber of the body.

16. The LED light bulb as claimed in claim 15, wherein the circuit board is mounted in the accommodating chamber, the first electrode and the second electrode are formed on the circuit board, wherein the first electrode is electrically connected with the third electrode via the mouth, and the second electrode is electrically coupled with the fourth electrode through the first opening.

17. The LED light bulb as claimed in claim 15, wherein the illumination unit includes at least one LED element electrically connected with the circuit unit, the at least one LED element is disposed on a first rim of a front section of the circuit board and a second rim of the front section of the circuit board opposite to the first rim.

18. The LED light bulb as claimed in claim 11, wherein one or both of the first shell and the second shell have at least one reinforcement rib formed on at least one inner surface of the first shell and the second shell, wherein the at least one reinforcement rib extends radially from the accommodating chamber to the body.

19. The LED light bulb as claimed in claim 18, wherein the driving circuit, the first electrode, and the second electrode are fixed on a circuit board, and the circuit board is secured in the accommodating chamber of the body, the accommodating chamber of the body also includes a holding plate for holding and fixing the circuit board of the circuit unit, wherein the holding plate has a gap for retaining the circuit board of the circuit unit.
